(19) United States
(12) Patent Application Publication
(10) Pub. No.: US 2003/0214549 A1
(43) Pub. Date: Nov. 20, 2003

(54) Inkjet Image forming apparatus

(75) Inventor: Seiji Ogasawara, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/435,478

(22) Filed: May 12, 2003

(30) Foreign Application Priority Data
May 14, 2002 (JP) 2002-138090

(51) Int. Cl. B41J 2/165

(52) U.S. Cl. 347/35

(57) ABSTRACT

The present invention relates to an inkjet image forming apparatus recordable of non-margin images on a recording medium by discharging ink to regions within as well as out of the recording medium from a recording means, comprising an ink absorbing material for receiving ink dischargeed at a position protruded from the recording medium and a platen having a holding portion to hold the ink absorbing material and supporting the recording medium at a recording position. The holding section formed at the platen has an opening for receiving the ink and is formed with a wall for holding a periphery of the ink absorbing material and a rib supporting a bottom of the ink absorbing material.

### BACKGROUND OF THE INVENTION

1. Field of the Invention

This invention relates to an inkjet image forming apparatus capable of recording with no margin at sheet edges by making recording up to positions protruded from the sheet edges.

2. Description of Related Art

Referring to FIG. 9 to FIG. 11, a prior art is described. An inkjet image forming apparatus has been conventionally known having a structure recordable of non-margin recording by providing an opening on a conveyance surface of a platen 100 for holding the sheet at an image forming position, forming a recess 101 made of vertical surfaces and a bottom surface below the opening, and providing an ink absorbing material (hereinafter referred to as “platen ink absorbing material”) at the recess 101, and the specific structure thereof is disclosed in JP-A-2000-118,058.

With such an inkjet image forming apparatus, because the platen ink absorbing material 102 is held by vertical four side walls and the bottom surface, if ink droplets are dischargeed in exceeding an ink permissive amount of the platen ink absorbing material 102, the ink may flow over the sheet conveyance surface of the platen 100 out of the platen ink absorbing material 102 and may cause sheet messing.

To solve this problem, as shown in FIG. 11, a structure has been known in which the ink overly flowing from the platen ink absorbing material 102 is prevented from flowing over the sheet conveyance surface of the platen 100 by arranging an ink absorbing material (hereinafter referred to as “connecting ink absorbing material”) for transmitting to an ink absorbing material (hereinafter referred to as “ink absorbing material”) for receiving ink discarded during absorption recovery operation of the ink discharging nozzles in the recording head or ink preliminary discharging operation.

With the above structure, however, the costs are inevitably increased because the connecting ink absorbing material is required at right and left ends of the respective sheet sizes to correspond the different sheet sizes.

### SUMMARY OF THE INVENTION

This invention is made to solve the above problems raised in the prior art. It is an object of the invention to provide an inkjet image forming apparatus capable of recording with no margin at sheet edges to prevent ink from flowing over a sheet conveyance surface of a platen out of a platen ink absorbing material with an inexpensive structure.

A representative structure according to the invention to accomplish the above object is an inkjet image forming apparatus recordable of non-margin images on a recording medium by discharging ink to regions within as well as out of the recording medium from a recording means, including an ink absorbing material for receiving ink dischargeed at a position protruded from the recording medium, and a platen having a holding portion to hold the ink absorbing material and supporting the recording medium at a recording position, wherein the holding section formed at the platen has an opening for receiving the ink and is formed with a wall for holding a periphery of the ink absorbing material and a grid shape rib supporting a bottom of the ink absorbing material.

As described above, according to the invention, an inkjet image forming apparatus recordable with no margin can prevent ink droplets discharged at a position out of a sheet from flowing over a conveyance surface of a recording medium of a platen with an inexpensive structure.

### BRIEF DESCRIPTION OF THE DRAWINGS

FIG. 1 is a perspective view of an inkjet image forming apparatus showing an embodiment of the invention;

FIG. 2 is a side cross section of the inkjet image forming apparatus showing the embodiment of the invention;

FIG. 3 is a schematic view showing an image forming range during non-margin recording with respect to the embodiment of the invention;

FIG. 4 is a perspective view showing a portion relating to the non-margin recording in the first embodiment of the invention;

FIG. 5 is a side cross section showing the portion relating to the non-margin recording in the first embodiment of the invention;

FIG. 6 is a perspective view of the portion relating to the non-margin recording in the first embodiment of the invention when seen from a bottom;

FIG. 7 is a perspective view showing a portion relating to the non-margin recording in the second embodiment of the invention;

FIG. 8 is a side cross section showing the portion relating to the non-margin recording in the second embodiment of the invention;

FIG. 9 is a perspective view showing a portion relating to the non-margin recording in an inkjet image forming apparatus as a prior art;

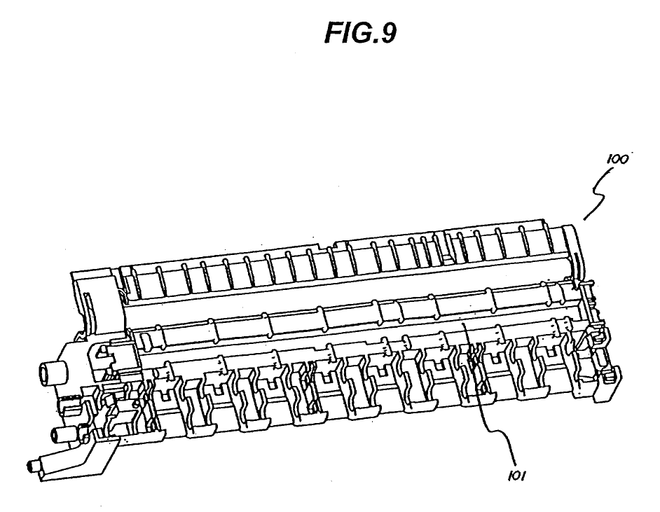

FIG. 10 is a side cross section showing a portion relating to the non-margin recording in an inkjet image forming apparatus as a prior art; and

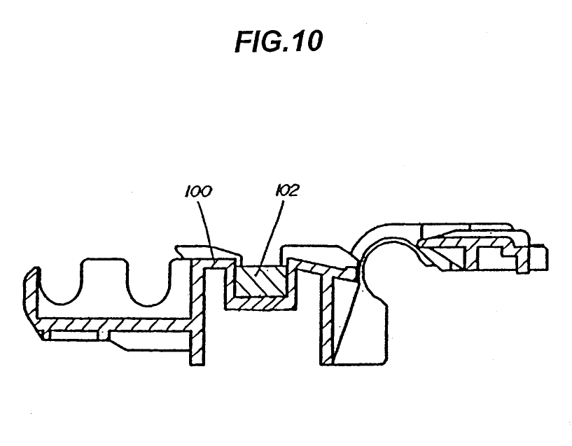

FIG. 11 is a side cross section showing a portion relating to the non-margin recording in an inkjet image forming apparatus as a prior art.

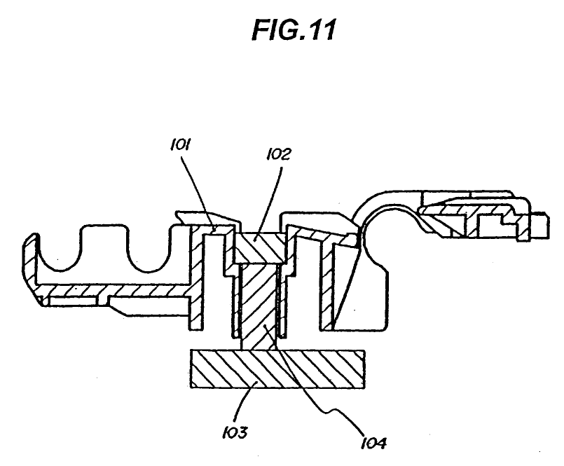

### DETAILED DESCRIPTION OF THE PREFERRED EMBODIMENTS

[First Embodiment]

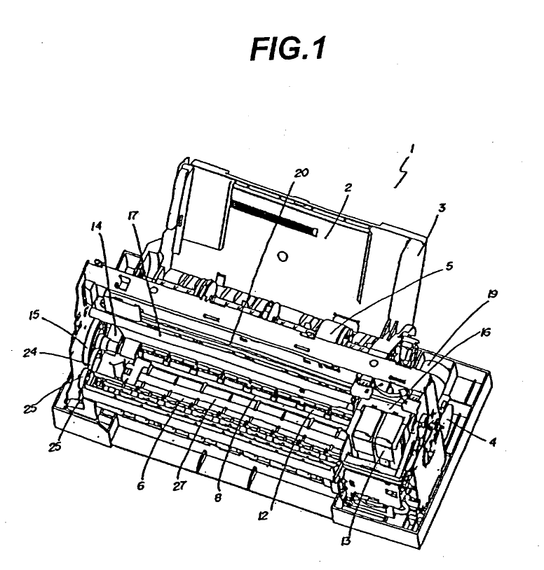

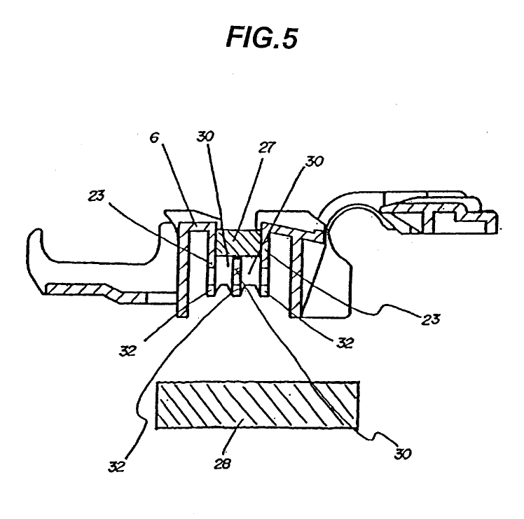

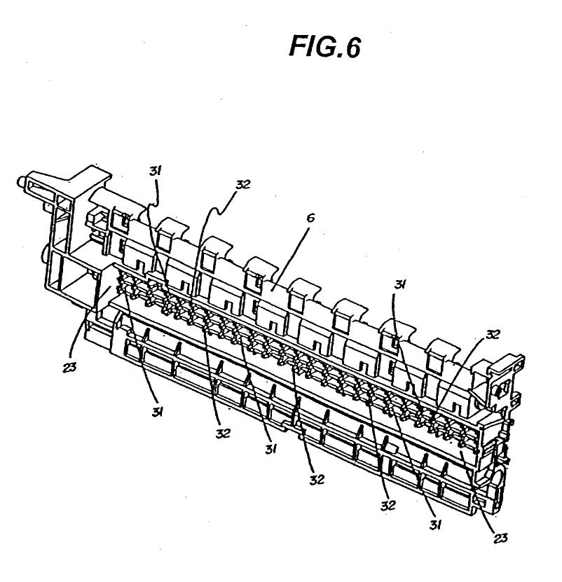

Hereinafter, an inkjet image forming apparatus according to the embodiment of the invention is described based on FIG. 1 to FIG. 6.

It is to be noted that the inkjet image forming apparatus of this embodiment is applicable to a photocopier, a facsimile machine, or the like, and is not limited to a printer.

[The Whole Structure]

First, an outlined structure of the entire apparatus and the operation of recording with no margin in which this invention's effect is advantageous are described.

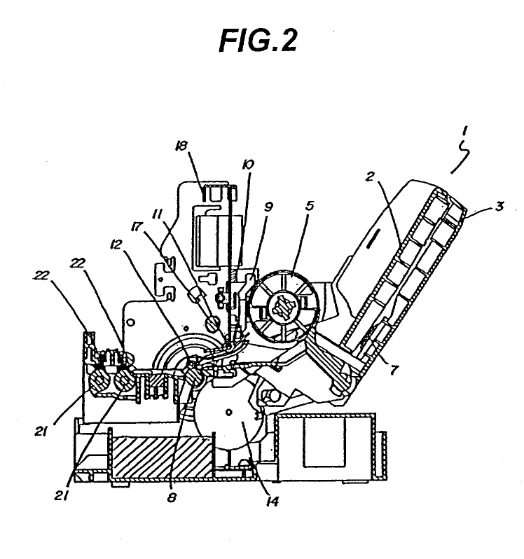

As shown in FIG. 1 and FIG. 2, a pressing plate 2 of a feeding apparatus 1 is supported pivotally to a feeding apparatus frame 3, and sheet bundles are stacked on a top face of the pressing plate 2. During sheet feeding, a feeding roller 5 rotates in association with a feeding motor 4 as a drive source, and the pressing plate 2 moves pivotally toward the feeding roller 5 in aid of a pressing plate spring 7 to press the sheet bundle to the feeding roller 5. Where the feeding roller 5 further rotates, the topmost sheet of the sheet bundle only is separated and fed to the downstream.

The sheet separated and fed by the feeding apparatus 1 is fed to a conveyance roller 8 according to further rotation of the feeding roller 5.

When the front end of the sheet separately fed from the feeding apparatus 1 pushes a sensor lever 9 disposed between the feeding roller 5 and the conveyance roller 8, the sensor lever 9 is pivotally moved, and when the sensor lever 9 moves beyond a sheet sensor 10, the front end of the sheet is detected. The rear end of the sheet is detected by entry of the sensor lever 9 to the sheet sensor 10.

The sheet is conveyed in a prescribed amount with a feeding roller 5 on the basis of the detected results of the front end of the sheet described above, and hits a nipping portion formed of a contact between the conveyance roller 8 and a pinch roller 12 urged to the conveyance roller 8 by a pinch roller spring 11. The sheet is further conveyed in a prescribed amount by the feeding roller 5 to curve the front end of the sheet, thereby pushing the front end of the sheet to the nipping portion, and rendering registration operation completed.

After the completion of the registration operation, the sheet is conveyed on a platen 6 by the conveyance roller 8, and is held by the top surface of the platen 6 at a position in opposition to a mounted surface of ink discharging nozzles of a recording head 13 serving as a recording means. The conveyance roller 8 is rotated via a conveyance roller gear 15 by a stepping motor 14 as a drive source.

Images are subsequently formed upon scanning a carriage 16 as discharging ink droplets out of the recording head 13 mounted on the carriage 16 across the sheet supported on a sheet passing surface of the platen 6. The carriage 16 is supported as capable of scanning in a direction perpendicular to the sheet conveyance direction with a guide shaft 17 and a guide rail 18 and is driven via a timing belt 20 by drive from a carriage motor 19.

It is to be noted that this recording head 13 has plural fine orifices, a fluid route, an energy operation section formed at a part of the fluid route, and an energy generating means for generating energy for producing droplets to be operated to a fluid in the operation section.

As an energy generating means for generating such energy, exemplified are a recording method using electromechanical converter such as piezo devices, a recording method using an energy generating means discharging droplets by operation of generated heats upon heat generation from radiation of electromagnetic wave such as a laser or the like, or a recording method using an energy generating means discharging fluid upon heating the fluid with an electro-thermal converter such as a heating device having a heat generating resistor.

A recording head used for the inkjet recording method in which fluid is discharged by thermal energy, among those, is able to make high resolution recording because the orifices for forming discharged droplets upon discharging the droplets for recording can be arranged with a high density. A recording head using the electro-thermal converter as an energy generating means, among those, advantageously can be readily made compact, readily mounted with a high density, and made with reduced manufacturing costs.

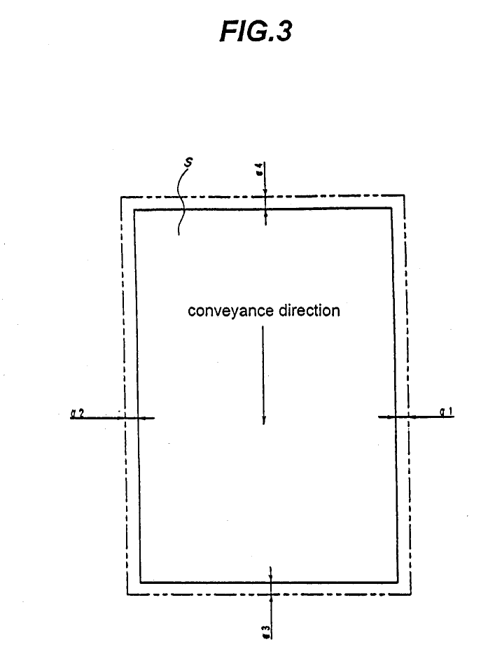

In this embodiment, as a discharging structure of the ink, recording is made by energizing the electro-thermal converter in accordance with a recording signal and by growing and contracting bubbles generated at the ink in utilizing film boiling occurring in the ink from the thermal energy to discharge the ink out of the orifices. Discharging thus ink upon growing and contacting bubbles with thermal energy accomplishes to discharge the fluid with excellent responding property.

Where recording with no margin is made to a sheet, a recording with no margin is realized by making recording as to protrude by prescribed amounts a1 to a4 in a manner shown with a double dotted chain line from four sheet edges with respect to a sheet S as an actual recording medium shown with a solid line as shown in FIG. 3. The prescribed amounts a1 to a4 are set in consideration of sheet conveyance accuracy and sheet cutting accuracy, and in fact, a distance of 2 to 3 mm is proper.

Finally, the sheet on which the image formation is completed is delivered to the exterior of the apparatus by a delivery roller 21 and a driven spur 22 pushed to the delivery roller 21 with a spur spring not shown. The delivery roller 21 is rotated via the conveyance roller gear 15, an intermittent gear 24, and a delivery roller gear 25 by the stepping motor 14 as a drive source.

[Platen Ink Absorbing Structure]

In the non-margin recording, ink is discharged to the exterior of the sheet region as described above. A platen ink absorbing body 27 for absorbing the ink dischargeed outside the sheet region is arranged at a holding portion of the platen 6. Next, a bottom structure of an opening (holding portion) of the platen 6 for holding the platen ink absorbing material 27 is described.

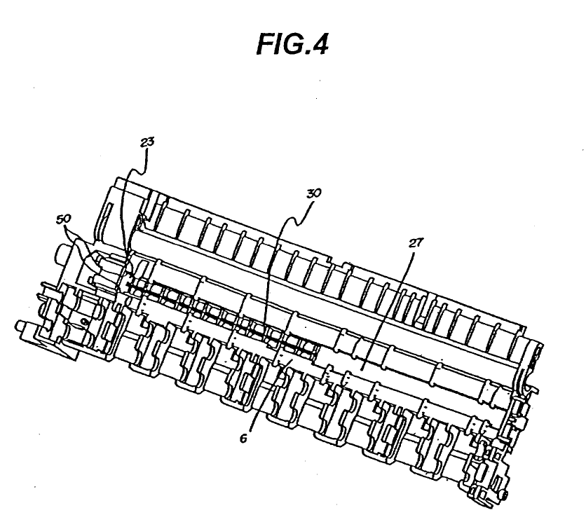

As shown in FIG. 4 to FIG. 6, the platen ink absorbing material 27 is held on a wall surface 23 extending substantially vertically downward from the opening formed on a sheet passing surface of the platen 6 as well as on a top surface of a grid shaped rib 30 extending substantially vertically downward in a way connecting the wall face 23 at a midway of the wall face 23.

With execution of the recording with no margin, ink droplets dischargeed at positions protruded from the sheet, arrive at a surface of the platen ink absorbing material 27. The ink arriving at the platen ink absorbing material 27 gradually immerses in directing downward in the platen ink absorbing material 27 by the self-weight. The material of the platen ink absorbing material 27 may be a highly foamed urethane of a low density or the like to make better the ink immersing property.

The ink remained at a lower portion of the platen ink absorbing material 27 moves downward through plural corners 31 formed as angled portions at the grid shaped rib 30 from the top surface of the grid shaped rib 30 in contact with a bottom surface of the platen ink absorbing material 27 by operation of surface tension force. The ink reaching the bottom of the grid shaped rib 30 becomes droplets, and drop and are absorbed in an apparatus ink absorbing material 28 formed further below.

Formation of protrusions 32 at the intersections of the lower surface of the grid shaped rib 30 structurally promotes ink reaching the lower surface of the grid shape rib 30 via the corners 31 to be integrated and dropped.

It is desirable to form the corners 50 reaching the sheet conveyance surface of the platen 6 in a curved shape to prevent the ink from transmitting due to effects of the surface tension force, like as the corners formed by the wall extending vertically downward from the opening formed on the sheet conveyance surface of the platen 6.

A surface of the wall 23 extending vertically downward from the opening formed on sheet conveyance surface of the platen 6 is desirably formed in a manner to reduce more water repellence property as closer to a lower portion from a vertically upper portion by adjustment of the surface roughness. This brings an effect to render ink contacting to the wall surface 23 promoted to transmit to the lower portion from a relation of the water repellence property.

In the embodiment as described above, with the inkjet image forming apparatus recordable of non-margin recording, the bottom surface of the opening of the platen 6 holding the ink absorbing material 27 for receiving the ink droplets discharged at positions protruded from the sheet is structured of the grid shape rib 30, and therefore, the ink overly flowing from the ink absorbing material 27 is transmitted from the corners 31 of the grid shape rib 30, thereby reaching the apparatus waste ink absorbing material disposed below the platen for receiving ink discarded by absorption recovery operation of the printer head and ink droplets preliminarily discharged.

In this operation, without use of any member such as an absorbing material for ink transmission for transmitting ink from the ink absorbing material 27 disposed at the platen opening to the apparatus ink absorbing material 28, this apparatus can prevent ink from flowing over the sheet conveyance surface of the platen out of the ink absorbing material disposed at the platen opening with the inexpensive structure.

[Second Embodiment]

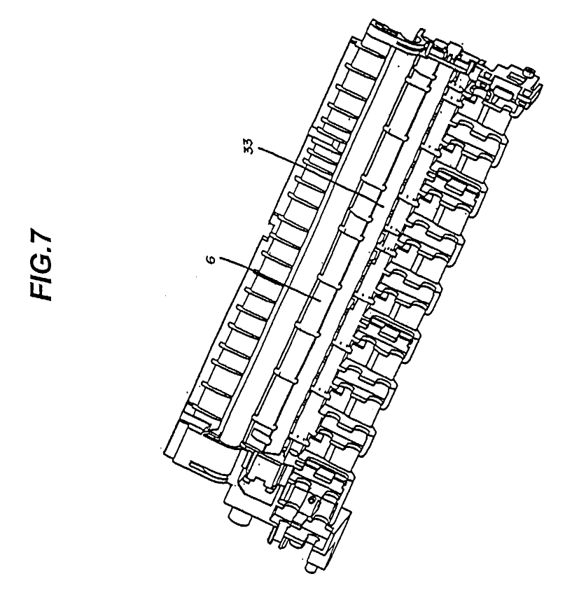

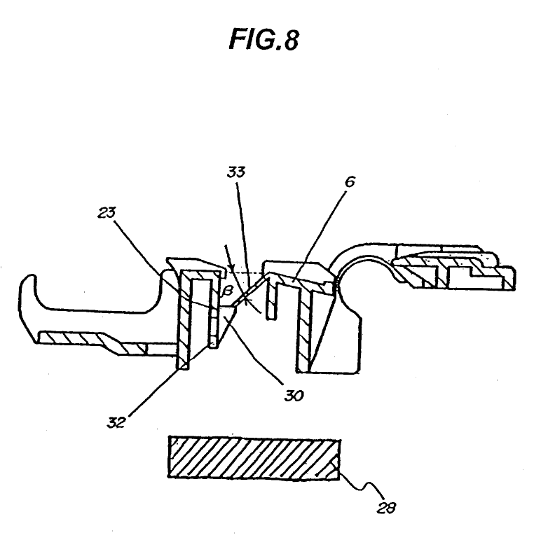

Referring to FIG. 7, FIG. 8, another embodiment of a platen ink absorbing structure is described. It is to be noted that the basic structure of the apparatus is substantially the same as that in the above described embodiment, and the same reference number is assigned to members having the same function.

As shown in FIG. 7, FIG. 8, in a platen ink absorbing structure according to this embodiment, a wall surface 23 extending vertically downward from the opening formed on the sheet conveyance surface of the platen 6 and a bottom surface secured to an outer periphery of the wall surface 23 are formed. An ink droplet discharging range by the recording head located at the bottom is of a slope 33 formed as inclined in the sheet conveyance direction. The slope 33 is inclined obliquely downward as directing to the wall surface on the other side from a top end on one side of the wall surface 23 in the sheet conveyance direction, but the lower end does not reach the wall surface on the other side, and the opening is formed. The grid shape rib 30 is formed as extending downward from the lower end of the slope 33 at the opening (the bottom surface except the slope 33).

With this structure, when recording with no margin is made, the ink droplets discharged at the positions protruded from the sheet arrives on the slope 33. The ink arrived at the slope 33 flows downward on the slope 33 by the self-weight. A part of the ink droplets arrived at the slope 33 is considered as rebounded to the slope 33. To prevent the rebounded ink droplets from jumping on the sheet conveyance surface of the platen 6, it is necessary to set angel â(beta) between the slope 33 and the horizontal plane to be 45 degrees or more. It is to be noted that formation of a groove or grooves along the inclined direction of the slope 33 may be effective to promote the ink arrived on the slope 33 to flow downward on the slope 33.

The ink flowing downward on the slope 33 moves to a lower portion via the plural corners 31 formed at the grid shape rib 30 by effect of the surface tension force from the top surface of the grid shape rib 30 extending downward from the lower end of the slope 33. The ink reaching the bottom of the grid shape rib 30 is dropped and absorbed to the apparatus ink absorbing material 28 formed at a further lower portion.

In substantially the same way as in the first embodiment described above, formation of protrusions 32 at the intersections of the lower surface of the grid shaped rib 30 promotes ink reaching the lower surface of the grid shape rib 30 via the corners 31 to be integrated and dropped. It is desirable to form the corners reaching the sheet conveyance surface of the platen 6 in a curved shape to prevent the ink from transmitting due to effects of the surface tension force, like as the corners formed by the wall 23 extending vertically downward from the opening formed on the sheet conveyance surface of the platen 6, or corners formed by the wall 23 and the slope 33.

It is also effective to promote the ink moving downward by reducing more the water repellence property as closer to the lower portion from the upper portion by adjustment of the surface roughness about the surfaces of the wall 23 extending substantially vertically downward and the slope 33 from the opening formed on the sheet conveyance surface of the platen 6.

As described above, in this embodiment, the costs thereof can be reduced because not only the connecting ink absorbing material but also the platen ink absorbing material is unnecessary.

[Third Embodiment]

In the second embodiment described above, a portion of the grid shape rib 30 forming the bottom of the opening formed on the sheet conveyance surface of the platen 6 may be formed in a through hole shape, and walls extending substantially vertically downward may be formed at the periphery of the through hole. With such a structure, ink flowing downward on the slope 33 falls in the apparatus waste ink absorbing material 28 arranged below in moving along the walls extending substantially vertically.

As described, in this embodiment, substantially the same advantage as that in the second embodiment can be obtained with the simpler platen structure.

Although in the respective embodiments described above the serial type image forming apparatus is described in which the recording head 13 is mounted on the carriage 16 and moved reciprocally to make inkjet recording, the ink absorbing structures in the above embodiments described above are applicable to a line type inkjet image forming apparatus performing image recording in discharging the ink on a basis of line as conveying the sheet where the ink discharging orifices are arranged in a width more than the sheet width.

What is claimed is:

1. An inkjet image forming apparatus recordable of non-margin images on a recording medium by discharging ink to regions within as well as out of the recording medium from a recording means, comprising:
an ink absorbing material for receiving ink discharged at a position protruded from the recording medium; and
a platen having a holding portion to hold the ink absorbing material and supporting the recording medium at a recording position,
wherein the holding section formed at the platen has an opening for receiving the ink and is formed with a wall for holding a periphery of the ink absorbing material and a rib supporting a bottom of the ink absorbing material.

2. The inkjet image forming apparatus according to claim 1, wherein the wall is vertical, and wherein the rib is a grid shaped rib extending downward from a position supporting the ink absorbing material.

3. The inkjet image forming apparatus according to claim 1, wherein a corner of the vertically extending wall positioned on the recording means side with respect to the ink absorbing material is in a curved shape.

4. An inkjet image forming apparatus recordable of non-margin images on a recording medium by discharging ink to regions within as well as out of the recording medium from a recording means, comprising:
a platen having a holding portion to hold the ink absorbing material;
wherein an opening is formed in a wall at a position corresponding to the recording means at the platen and a slope is formed at least a part of the opening and inclined with respect to a conveyance direction of the recording medium.

5. The inkjet image forming apparatus according to claim 4, wherein the slope is secured to a vertical wall at an outer periphery thereof.

6. The inkjet image forming apparatus according to claim 4, wherein the slope is inclined with an angle of 45 degrees or more with respect to the conveyance direction of the recording medium.

7. The inkjet image forming apparatus according to claim 4, wherein the opening except the slope has a grid shape rib extending downward from a lower edge of the slope.

8. The inkjet image forming apparatus according to claim 4, and further comprising a wall extending vertically downward from the lower edge of the slope.

9. The inkjet image forming apparatus according to claim 4, wherein the slope includes at least one groove disposed in an inclined direction.

10. The inkjet image forming apparatus according to claim 1 or claim 4, wherein the wall has a lower water repellence property as closer to a lower portion from an upper portion.

11. The inkjet image forming apparatus according to claim 1 or claim 7, wherein the grid shape rib has a protrusion at an intersection on a lower surface thereof.

12. The inkjet image forming apparatus according to any one of claim 1 to claim 9, wherein the recording means energizes an electro-thermal converter according to a signal and discharges an ink by utilizing film boiling occurring in the ink from the thermal energy generated at the electro-thermal converter.
